(19) United States
(12) Patent Application Publication
(10) Pub. No.: US 2007/0062540 A1
(43) Pub. Date: Mar. 22, 2007

(54) Respiratory monitoring apparatus and related method

(76) Inventor: Scott C. Murray-Harris, Muskegon, MI (US)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 11/231,250

(22) Filed: Sep. 20, 2005

(51) Int. Cl. A62B 9/06

(52) U.S. Cl. 128/207.29; 128/207.14

(57) ABSTRACT

A tracheotomy apparatus including a cuff, a port and a sensor. The cuff defines a chamber and wraps around a portion of the subject's neck. A fluid delivery system delivers a gas to the chamber through the port as the subject naturally respires. The sensor monitors carbon dioxide in another gas exhaled from the subject as the subject naturally respires. The sensor can be coupled to a controller that monitors pre-selected parameters, and optionally activates an alarm when those parameters are unmet. A related method includes aligning the tracheotomy cuff with a subject's tracheotomy tube; delivering a first gas so that the subject can naturally respire, drawing the gas from the apparatus; and monitoring a second gas exhaled by the subject into the tracheotomy cuff. Optionally, an alarm is activated when the monitored parameters fall outside pre-selected parameters.

### BACKGROUND OF THE INVENTION

The present invention relates to respiratory equipment, and more particularly to tracheotomy cuffs.

A tracheotomy is a surgical procedure in which an opening is formed in the neck of a subject, in particular the trachea, to allow passage of the air to the subject's lungs. Usually, a tracheotomy tube (a “trach tube”) is placed in the opening to keep it from healing closed.

A tracheotomy typically is performed on a subject who has respiratory failure, or insufficiency such that the subject must be placed on a mechanical ventilator to help them breathe. After their breathing becomes improved—due to medical intervention and/or use of the mechanical ventilator—such subjects are taken off the ventilator, and begin to breathe naturally again with their own respiratory system.

Sometimes, however, the respiration of such recovering subjects is tenuous, and must be assisted. To provide such assistance, supplemental oxygen in gaseous form is supplied to the subject through a tracheotomy cuff. Many times, however, the oxygen supplied through the tracheotomy cuff is compromised, either due to pulmonary secretions occluding the tracheotomy and blocking the oxygen supply, or the accidental or intentional removal of the trach cuff or both. As a result, the subject may become hypoxic (i.e., does not receive enough oxygen), which is some cases, can lead to anoxic brain injury and, in worse cases, death; moreover, such patients requiring tracheotomies are often debilitated from other illnesses and/or medical treatments that can compromise respirations and lead to anoxic brain injury.

To ensure that a trach cuff is adequately installed and provides the required oxygen, a pulse oximeter is used. A pulse oximeter is a device that fits over a finger of the subject to provide an indirect measurement of arterial oxygen saturation. It does not, however, provide information regarding the adequacy of respiration and/or ventilation in a timely manner. For example, arterial oxygen saturation provides a lagging indicator of hypoxemia in the finger, and inferentially the state of ventilation or respiration of the subject. Moreover, the accuracy pulse oximetry is limited by: adequate peripheral arterial perfusion; proper fitting of the pulse oximeter; and the subject's willingness to leave the pulse oximeter installed. Further, pulse oximeters provide frequent false alarms that often are ignored, or responded to in a tardy fashion by an attending healthcare provider. In some cases, where the alarm is true and an attendant fails to timely check the subject, this can lead to harm, and in some cases, death.

### SUMMARY OF THE INVENTION

The aforementioned problems are overcome by the present invention, which provides a tracheotomy apparatus including a tracheotomy cuff, a port and a sensor. The cuff defines a chamber and wraps around a portion of the subject's neck. A fluid delivery system is in communication with the port to deliver a gas including oxygen to the chamber through the port as the subject naturally respires. The sensor monitors carbon dioxide in another gas exhaled from the subject as the subject naturally respires. An optional securing element is joined with the cuff to secure the tracheotomy cuff to the neck.

In one embodiment, the sensor is coupled to a controller and an alarm. The controller activates the alarm when carbon dioxide or other gases fall outside pre-selected parameters, such as specific carbon dioxide levels, specific frequency or amplitude of inhalation or exhalation, and/or specific changes in the frequency or amplitude of carbon dioxide levels as the subject respires.

In another embodiment, the trach cuff includes a pressure sensor that measures the barometric pressure at the tracheotomy site. Optionally included is a controller that receives input from the pressure sensor and or gas sensor, analyzes the barometric and capnographic information from the sensors for amplitude and/or frequency, and subsequently determines the adequacy of respiration of the subject. If the respiration is inadequate, an alarm is activated.

In yet a further embodiment, the tracheotomy cuff includes a retaining ring defining an aperture. The retaining ring fits around a subject's trach tube to secure the cuff loosely to the tube.

A related method includes: providing a tracheotomy cuff according to any of the embodiments above; aligning the tracheotomy cuff with a tracheotomy tube projecting from the subject's neck; securing the tracheotomy cuff to the subject's neck; delivering a gas to the tracheotomy cuff so that the subject can respire naturally; and monitoring a second gas exhaled by the subject into the tracheotomy cuff. The method optionally includes securing the tracheotomy cuff around a portion of the subject's neck so that a tracheotomy cuff extending from the subject's neck extends at least partially into a tracheotomy cuff chamber defined by the tracheotomy cuff.

In another embodiment, the method includes activating an alarm when characteristics of the second gas fall outside the pre-selected parameters, such as specific carbon dioxide levels, specific frequency or amplitude of inhalation or exhalation, and/or specific changes in the frequency or amplitude of carbon dioxide levels as the subject respires.

In a further embodiment, the method can include monitoring the pressure of the gas exhaled by the subject and activating an alarm when pre-selected pressure parameters are unmet.

The present tracheotomy apparatus and related method provide a simple and efficient way to monitor the adequacy of respiration by a subject and the installation of a tracheotomy cuff at a trach site. With the analysis of capnographic data for amplitude and/or frequency, the adequacy of respiration can be determined. Where a controller and alarm is included, the alarm can be activated to notify an attending healthcare provider that the subject's respiration is unsatisfactory and/or the trach cuff has been removed from the trach site. As a result, the device and method can provide a real time warning of a present and/or impending respiratory problems before serious injury, such as hypoxia, anoxic brain injury, or death occurs. Such early warning also can provide the attending healthcare provider with more time for lifesaving intervention. Furthermore, the device and method provide more timely information to guide treatment decisions, which can reduce treatment cost, discomfort to the subject, and hospital stay.

These and other objects, advantages and features of the invention will be more readily understood and appreciated by reference to the detailed description of the invention and the drawings.

### BRIEF DESCRIPTION OF THE DRAWINGS

FIG. 1 is a sectional view of an embodiment of the tracheotomy apparatus installed on a subject;

FIG. 2 is a top view of the tracheotomy apparatus;

FIG. 3 is a interior view of the tracheotomy apparatus;

FIG. 4 is a top view of a first alternative embodiment of the tracheotomy apparatus;

FIGS. 5 and 6 are cross-sectional views of the first alternative tracheotomy apparatus taken along lines 5-5 and 6-6 of FIG. 4, respectively;

FIG. 7 is a retaining ring optionally used with the tracheotomy apparatus;

FIG. 8 is a first graph showing the concentration of a gas monitored with the tracheotomy apparatus;

FIG. 9 is a first graph showing the pressure of a gas monitored with the tracheotomy apparatus;

FIG. 10 is a second graph showing the concentration of a gas monitored with the tracheotomy apparatus;

FIG. 11 is a second graph showing the pressure of a gas monitored with the tracheotomy apparatus;

FIG. 12 is a third graph showing the concentration of a gas monitored with the tracheotomy apparatus; and

FIG. 13 is a third graph showing the pressure of a gas monitored with the tracheotomy apparatus.

### DETAILED DESCRIPTION OF THE PREFERRED EMBODIMENT

I. Overview

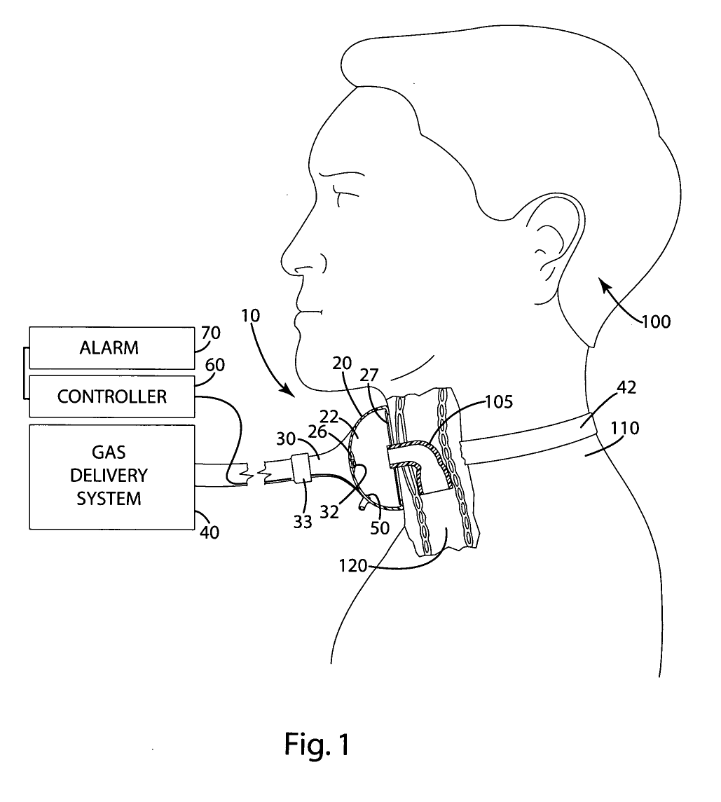

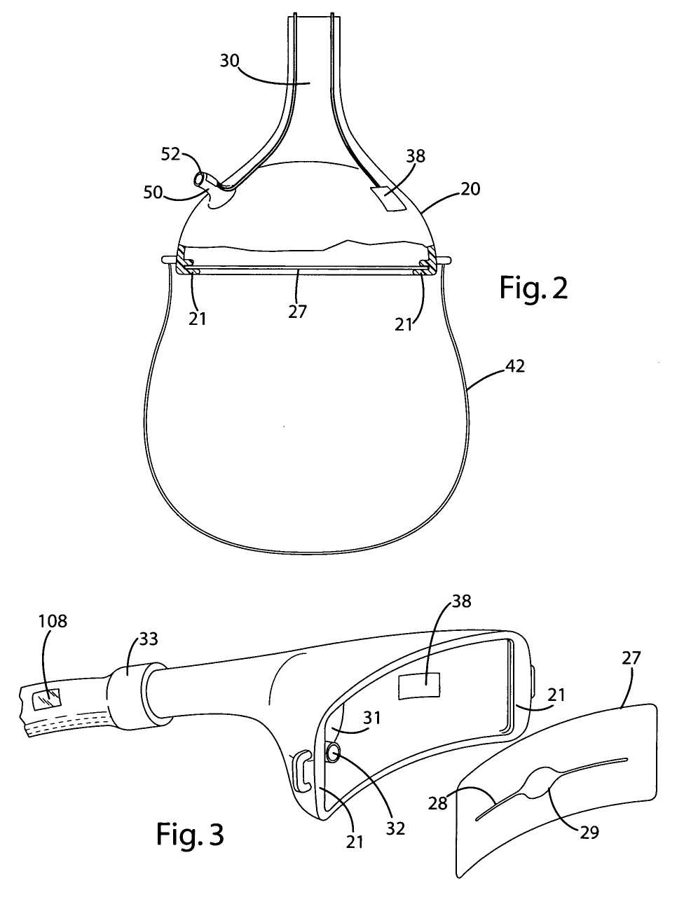

A tracheotomy apparatus is shown in FIGS. 1-7 and generally designated 10. As shown, the apparatus includes a trach cuff 20 to which a tube 30 is secured. The tube 30 includes an oxygen tube 32, which is in fluid communication with a gas delivery system 40. The trach cuff 20 includes a carbon dioxide sensor 50 which is coupled to the controller 60. The controller 60 is further in communication with an alarm 70. The controller 60 can actuate the alarm 70 to produce an audible and/or visual signal indicative of the installation of the trach cuff 20 and/or status of respiration of the subject 100.

In general, the trach cuff 20 is positioned over the trach tube 105, which is inserted in the trachea 120 of the subject 100, so that at least a portion of the trach tube 105 extends into the trach cuff chamber 22. An optional retaining ring 27 is used in conjunction with the trach cuff 20 to provide additional and/or alternative securement of the trach cuff to the trach tube 105.

Gas, such as oxygen, is delivered from the gas delivery system 40 through the oxygen tube 32, into the trach chamber 22. The subject 100, who is naturally respiring without the aid of mechanical assistance such as a ventilator, can breath the gas delivered to the chamber 22 through the trach tube 105. The gas exhaled by the subject 100 from the trach tube 105 enters the chamber 22, and is sensed by the sensor 50, which optionally can be disposed in an exhaust port 52. The sensor senses carbon dioxide in the exhaled gas and transmits related data to the controller.

The controller monitors pre-selected parameters associated with the sensed carbon dioxide, for example, quantitative and/or qualitative levels of carbon dioxide or other gases in the exhaled gas, and/or the amplitude and/or frequency of the exhaled gas and/or carbon dioxide over time. When the controller determines that the pre-selected parameters fall outside acceptable ranges, which can coincide with specific concentrations of carbon dioxide or other gas, and/or specific frequencies or amplitudes of normal breathing, the controller can control the alarm 70 to produce an audible or visual signal or output to an attending healthcare provider. Usually, when the controller determines that measured values fall outside acceptable ranges and activates the alarm, this indicates to the healthcare provider that the subject is experiencing an undesired respiratory condition or that the apparatus is improperly installed or has been removed from the subject's neck.

II. Construction

With reference to FIGS. 1-7, the apparatus will now be described in more detail. The apparatus 10 includes a trach cuff 20 which defines a chamber 22 therein. In fluid communication with the chamber 22 is an air tube 30, which can include an internal oxygen delivery tube 32 that terminates at a port disposed within the chamber 22. The tube 30 can include an internal exhaust port 31 through which exhaled gas can travel. The air tube 30 also can be outfitted with a ball connector 33. This ball connector can prevent kinking of the tube 30. In addition, the ball connector can increase the comfort of the subject by reducing unnecessary movement of the trach cuff when the subject moves or is repositioned.

The air tube as shown can be connected to a gas delivery system that produces or stores a desired gas, such as oxygen, for delivery to the trach cuff 20. The components and operation of the gas delivery system 40 are common, and will not be described in detail here.

The air tube 30 and trach cuff 20 can be designed to be removable from the ball connector 33, and/or disposable to prevent the passage of communicable diseases from one subject to the next. Alternatively, the trach cuff 20 and other components of the apparatus 10 can be constructed from materials that are easily sanitized or cleaned before use with a different subject.

As shown in FIGS. 1-4, the trach cuff 20 can also include retaining edges 21 that secure a retaining ring 27. These edges can be replaced with any structure that secures the retaining ring to the cuff 20 as desired. The retaining ring lightly snaps in place behind the edges 21 to prevent lateral movement of the cuff. The ring 27 can define a slit 28 and optionally an aperture 29 designed to fit over the exposed portion of a trach tube 105 extending from subject's neck 110. The retaining ring need not connect directly to the trach tube 105, but can instead simply fit loosely around the trach tube 105. With this low-strength connection of the trach cuff 20 to the trach tube 105, the risk of pulling the trach tube from the trachea 120 is reduced if the cuff is accidentally pulled or moved. The retaining ring can disposable, and can be constructed from a plastic, elastomeric or rubber material as desired.

As discussed above, the carbon dioxide sensor 50 can be disposed in an exhaust port 52 in fluid communication with the trach cuff 20. The sensor 50 is also in electrical communication with the controller 60. The sensor 50 optionally is adapted to measure levels of a gas, such as carbon dioxide, present in the chamber 22, as the subject 100 naturally respires.

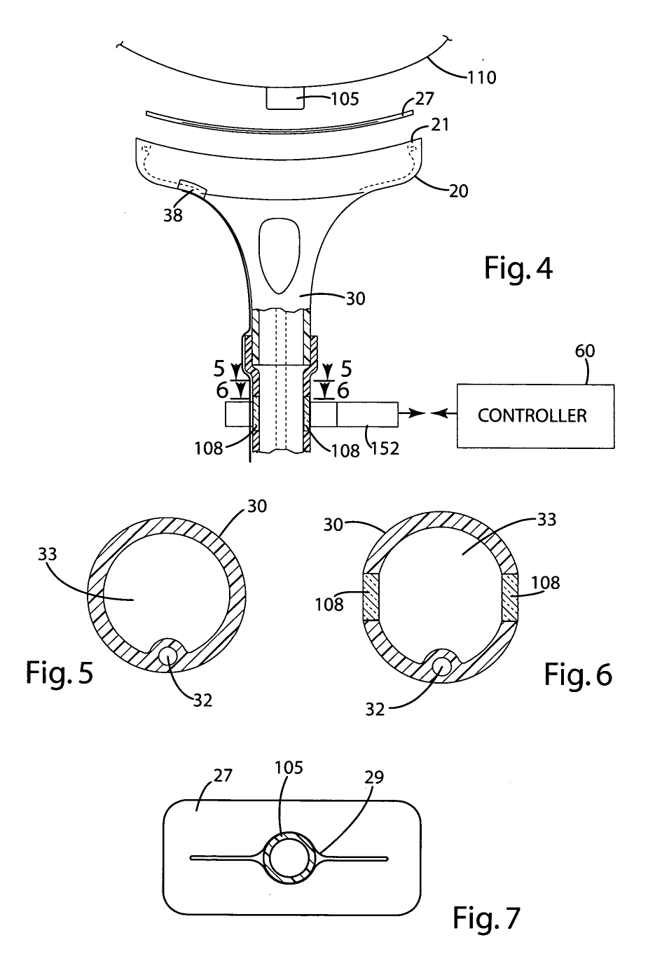

Other types of carbon dioxide sensing mechanisms can be used in connection with the present tracheotomy apparatus 10 to monitor gas exhaled by the subject into the tracheotomy cuff 20. For example, as shown in FIGS. 3 and 4, the air tube 30 can include translucent or transparent windows 108. An infrared carbon dioxide sensor 152 can be used to sense the concentration, quantitatively or qualitatively, of carbon dioxide or other gases through the windows 108. The data collected by the sensor 152 can be transmitted to the controller 60, which in turn can function as described below.

Returning to FIGS. 1-3, the trach cuff can also include a pressure sensor 38 in fluid communication with the trach cuff chamber 22, and further coupled to the controller 60 via an electrical wire. The pressure sensor 38 is adapted to sense pressure, and thus pressure fluctuations due to respiration, within the chamber 22 and/or other parts of the tracheotomy apparatus 10. This information is transferred to the controller and can be used alone or in combination with the other data collected by the carbon dioxide sensor 50 as explained in further detail below. Optionally, the sensors 50 and 38 need not be hard wired directly to the controller 60. Rather, either or both sensors can include infrared or RF transmitters that transmit data sensed by those sensors to the controller 60.

The controller 60 as shown in FIGS. 1 and 4 is in communication with and receives input from sensor 50 and optional sensor 38. The controller also is in communication with the alarm 70. Optionally, the controller 60 and alarm 70 are positioned in close proximity to the subject, or positioned remotely at a monitoring station as desired.

The concentration of gaseous carbon dioxide, as well as the optionally measured barometric pressure, fluctuate during respiration at the trach site. For example, the gaseous carbon dioxide levels and barometric pressure increase in the chamber 22 during expiration, and decrease during inspiration. The controller 60 is designed to monitor several conditions based on the sensing of the carbon dioxide and/or barometric pressure during respiration. As a result of this monitoring, the controller can actuate the alarm 70 to produce an audible and/or visual warning to an attending healthcare provider. To the healthcare provider, the warning will signify a respiratory problem or removal of the trach cuff 20 from the trach site, and subsequent removal of the supplemental oxygen flow to the trach cuff. Accordingly, the attending healthcare provider can intervene. Specific, monitored conditions are explained below in connection with operation and method of use.

Optionally, the controller 60 is adjustable within limits to reflect subject-specific parameters, for example, expected fluctuation in carbon dioxide concentration and/or barometric pressure, as well as frequency of breath. Further optionally, the controller 60 can include an apnea detector which detects when no breath is taken within a 6-second interval regardless of the detected respiratory rate. When such condition is detected, the controller can actuate the alarm 70.

III. Operation and Method of Use

The use and operation of the tracheotomy apparatus 10 will now be described in more detail. The trach apparatus 10 can be used on a subject who has a trach tube 105 positioned in their trachea 120, and who is able to naturally respire, that is, breath without additional mechanical intervention provided through a closed respiratory system in which a mechanical ventilator or other device pumps a pressurized gas directly into the subject's trachea. Indeed, the tracheotomy apparatus is suitable to wean subjects after they are on a mechanical ventilator, until they are capable breathing on their own without requiring a supplemental oxygen source.

To install the tracheotomy apparatus 10, the trach cuff 20 is first provided. When used, the optional retaining ring 27 is placed over the portion of the trach tube 105 projecting from the subject's neck 110 as shown in FIG. 7. The trach cuff 20 then is aligned with the trach tube 105, and the optional retaining ring 27, and secured to the subject's neck 110 with an elongate member 42. The elongate member can be an elastomeric, fabric or synthetic strap that wraps around the remaining portion of the subject's neck 110. Additionally, when the optional retaining edges 21 are present, the retaining ring 27 snaps in place behind those edges as the cuff is secured to the patient's neck, to provide further securement of the cuff.

When installed, the trach tube 105 is located within the boundaries of the trach cuff 22. Additionally, a portion of the tube 105 extends at least partially into the chamber 22 defined by the trach cuff 20 as shown in FIG. 1.

With the trach cuff installed around the subject's neck, the oxygen tube 32 can be connected to the gas delivery system 40. The sensors 50 and 38 are coupled to the controller 60, which is further coupled to the alarm 70. The gas delivery system 40 is activated to deliver a first gas, e.g., oxygen, through the port 32 into the chamber 22. The subject can then breath naturally, inspiring the gas from the chamber 22 into the subject's respiratory system, and expiring another gas including carbon dioxide from the subject's respiratory system into the chamber 22. This expired gas can flow into the exhaust tube 30, and into the environment, or out through a vent open to the environment in the gas delivery system 40.

Optionally, an attending healthcare provider can calibrate the controller to the specific respiration of the subject. For example, the provider can determine what is the “normal” level of carbon dioxide expired from the subject, and/or the normal frequency or amplitude of the subject's respiration, and program this data into the controller. The provider can then program the controller to activate the alarm if later monitored carbon dioxide levels or respiratory frequency or amplitude fall outside the normal parameters for that subject.

With the trach cuff installed, the subject breathing naturally, and the controller calibrated where necessary, the monitoring can begin. Specifically, gas exhaled by the subject 100 is sensed by sensor 50 and optional sensor 38. Data related to the sensed gas is output to the controller 60, which processes this information. As noted above, the general operation of the controller is based on the following principal: if the controller determines that the data becomes unreliable and/or falls outside pre-selected parameters, then the controller can activate the alarm to produce an audible or visual warning to an attending healthcare provider.

In one embodiment, the controller monitors the difference between inspired and expired carbon dioxide and uses this information to determine whether or not to actuate the alarm. This embodiment relies on the fact that inhaled atmospheric carbon dioxide is around 375 ppm or about 0.033%. In contrast, exhaled carbon dioxide is about 50,000-60,000 ppm or about 5.57%. Exploiting this difference, the controller 60 monitors both inhaled and exhaled carbon dioxide. In general, it can be assumed that a difference of between 2% and 3% carbon dioxide concentration can be expected between breaths.

Using this information, the controller is calibrated so that if the difference is less than about 2%, the controller will actuate the alarm. As will be appreciated, the relative percentage difference can be changed by an operator, for example, an attending healthcare provider. In addition, the controller 60 can also monitor an upper limit of the carbon dioxide difference between breaths. For example, if the carbon dioxide difference is over about 5.7%, the controller can actuate the alarm with a specific message that there is a potential problem with the controller because there should not be such a significant level of carbon dioxide detected.

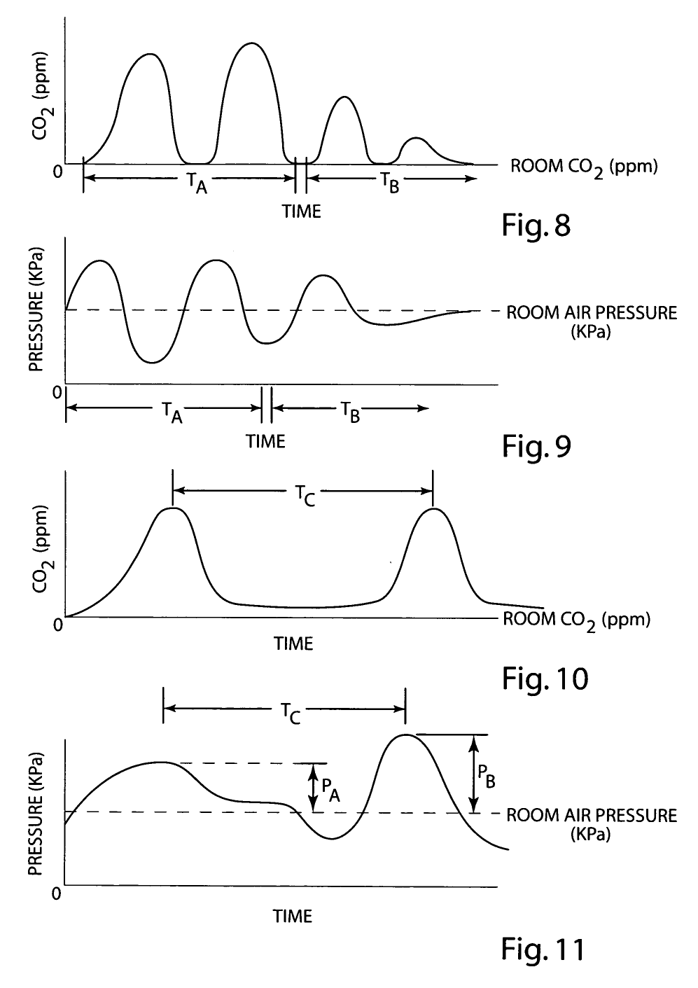

Several conditions can cause the controller 60 to produce the alarm. The following are examples of such conditions. First, removal of the trach cuff from the trach site or respiratory failure can cause the sensed the carbon dioxide levels and/or barometric levels to terminate or to fall below minimum prescribed respiratory frequency and amplitude parameters. Such a condition is shown at the graphs in FIGS. 8 and 9. The graph at FIG. 8 shows the concentration of carbon dioxide (parts per million) in gas exhaled from a subject as detected over time with the trach apparatus 10. During period Tₐ, carbon dioxide concentrations naturally rise during expiration and naturally fall to the baseline ambient room carbon dioxide concentration during inspiration by the subject. The period T_{b} is representative of a condition, such as removal of the trach cuff from the trach site or respiratory failure. During this period, the monitored carbon dioxide levels decrease, as indicated by the smaller peaks during time T_{b}. This decrease during time T_{b} would be detected by the controller, and noted as falling outside pre-selected parameters for amplitude representative of the normal concentration of carbon dioxide. As a result, the controller would activate the alarm 70 to indicate that there may be a problem, such as respiratory failure and/or removal of a trach cuff from the subject's neck.

The graph at FIG. 9 shows the pressure (kilopascals) of gas exhaled from a subject as detected over time when the trach apparatus 10 includes an optional pressure sensor. Pressure within the chamber 22 due to normal respiration is shown during time Tₐ relative to ambient room air pressure. During time T_{b}, which is associated with the condition of respiratory failure and/or removal of the tracheotomy cuff from the subject's neck, the pressure sensed during inspiration and expiration decreases. This decrease in pressure would be detected by the controller as falling outside pre-selected parameters for pressure variation. As a result, the controller would activate the alarm.

A second condition that the controller 60 can detect and, if necessary activate the alarm 70, occurs when a subject outfitted with the trach apparatus 10 undergoes apnea or hypopnea. Such a condition is shown in the graphs at FIGS. 10 and 11. As shown in FIG. 10, the amount of time T_{c} between breaths by the subject is detected by the controller as being longer than a “normal” amount of time between breaths, which is indicative of temporary cessation or excessive slowing of respiration. As a result, the controller can actuate the alarm 70.

When the optional pressure sensor is included in the apparatus 10, the controller 60 also can monitor the pressure generated by breathing to detect apnea and/or hyponea. For example, in FIG. 11, P_{b} represents a “normal” pressure to be expected during expiration. If the pressure falls below this pressure, for example, to pressure Pₐ, this is indicative of temporary cessation or excessive slowing of respiration. As a result, the controller can actuate the alarm 70. The resultant cessation or excessive slowing of respiration also can indicate excessive sedation or neurological impairment of respiration. The controller can sense this and actuate the alarm when it detects lower than expected amplitude of barometric pressure even when carbon dioxide fluctuations are adequate.

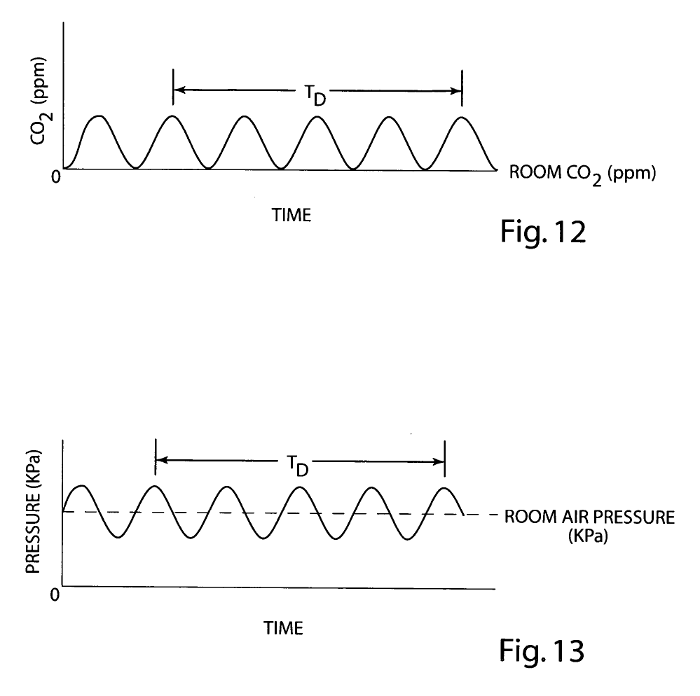

Another condition that the controller 60 can indirectly monitor concerns respiratory secretions from pneumonia, pulmonary edema or other diseases or conditions that cause such secretions. For example, excessive secretions can cause an excessive respiratory rate and/or gaseous carbon dioxide concentrations to fall. Such a condition can be monitored and detected by the controller, as shown in the graphs at FIGS. 12 and 13. Over time T_{d}, the detected respiratory rate becomes rapid due to excessive secretions of a subject. This is indicated by an increased frequency of carbon dioxide concentration changes (and corresponding lower levels of detected carbon dioxide), in addition to an increased frequency of pressure change during time T_{d}. The controller 60 can determine that these rapid fluctuations and lower concentrations fall outside pre-selected parameters indicative of normal frequencies and concentrations. As a result, the controller can actuate the alarm 70.

Yet another condition that can cause the controller 60 to produce the alarm is when the subject undergoes anxiety and/or pain. Anxiety or pain can cause the frequency of inspiration and expiration, and thus the frequency of changes in carbon dioxide levels and pressure, to increase. Such a condition can be monitored by the controller in a manner similar to that explained above in connection with excessive respiratory secretions and as shown in the graphs at FIGS. 12 and 13.

A further condition detectable by the controller is respiratory fatigue. During respiratory fatigue, the amplitude of carbon dioxide concentration and pressure will be lower. There also may be an increase in the frequency of the subject's expiration/inspiration. Such a condition can be monitored by the controller, as shown with further reference to the graphs at FIGS. 12 and 13. As explained in connection with the condition of excessive respiratory secretions above, when the fluctuations in amplitude fall outside pre-selected parameters, i.e., pre-selected amplitude expected for carbon dioxide and/or pressure, the controller can actuate the alarm 70 to warn the attending healthcare provider of potential patient respiratory fatigue.

It is noted that the above monitored conditions are exemplary only, and that the apparatus 10 can be used to monitor for complications of any medical condition that influences respiration. As desired, the apparatus can further actuate an alarm when the monitored information falls outside pre-selected parameters to indicate that the medical condition has influenced respiration.

The above descriptions are those of the preferred embodiments of the invention. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular.

The embodiments of the invention in which an exclusive property or privilege is claimed are defined as follows:

1. A method for delivering a fluid to and monitoring a subject having a tracheotomy comprising:
providing a tracheotomy cuff including a body portion defining a chamber, the tracheotomy cuff shaped to wrap around a portion of the subject's neck, the tracheotomy cuff including a first fluid port adapted to deliver a first fluid to the subject and a second fluid port adapted to receive at least a portion of fluid exhaled from the subject;
aligning the tracheotomy cuff with a tracheotomy tube extending from the subject's neck;
securing the tracheotomy cuff around a portion of the subject's neck so that the tracheotomy tube extends at least partially into the tracheotomy cuff chamber;
delivering a first fluid from a fluid production device through the first fluid port to the tracheotomy cuff chamber so that the subject can naturally inhale the first fluid under the power of the subject's respiratory system; and
monitoring a second fluid naturally exhaled by the subject through the tracheotomy tube through the second fluid port.

2. The method of claim 1 comprising securing a strap around the subject's neck.

3. The method of claim 1 wherein the first fluid includes oxygen, and the second fluid includes carbon dioxide.

4. The method of claim 1 wherein the monitoring step includes comparing the amount of carbon dioxide in the second fluid to a predetermined level of carbon dioxide.

5. The method of claim 1 comprising sounding an audible alarm when the second fluid includes an amount of carbon dioxide that is less than a pre-selected value.

6. The method of claim 1 comprising producing a visual alarm when the second fluid includes an amount of carbon dioxide that is less than a pre-selected value.

7. The method of claim 1 comprising measuring the frequency of at least one of exhalation and inhalation of the subject to determine if the tracheotomy cuff is positioned at least partially around the subject's neck.

8. The method of claim 1 wherein the tracheotomy cuff includes a retaining ring and further comprising fitting the retaining ring over at least a portion of the tracheotomy tube during the securing step.

9. The method of claim 1 wherein the tracheotomy tube contacts no portion of the tracheotomy cuff when the cuff is fully secured around at least a portion of the subject's neck.

10. A method comprising:
providing a tracheotomy cuff including a body adapted to wrap at least partially around the neck of the subject, the tracheotomy cuff defining a chamber, the tracheotomy cuff including a port that delivers a first gas to the chamber;
aligning the tracheotomy cuff with a tracheotomy tube projecting from the subject's neck;
positioning the tracheotomy cuff so that at least a portion of the body engages the subject's neck and so that the tracheotomy tube projects at least partially in the tracheotomy cuff chamber; and
delivering the first gas to the chamber so that the subject can respire naturally with the subject's own respiratory system through the tracheotomy tube, drawing the first gas from the chamber; and
monitoring a second gas exhaled by the subject into the tracheotomy cuff.

11. The method of claim 10 monitoring carbon dioxide in the second gas and activating an alarm when the measured carbon dioxide is outside pre-selected parameters.

12. The method of claim 10 wherein the monitoring step includes monitoring the frequency at which the subject exhales.

13. The method of claim 10 comprising activating an alarm when the frequency of exhaling is below a pre-selected frequency.

14. The method of claim 10 wherein the monitoring step includes monitoring the pressure of the second gas exhaled by the subject.

15. The method of claim 14 wherein the monitoring step includes monitoring the amount of carbon dioxide in the second gas.

16. The method of claim 15 comprising recording the pressure of the second gas and the amount of carbon dioxide in the second gas.

17. A tracheotomy apparatus that delivers and monitors gases comprising:
a tracheotomy cuff body defining a chamber and including neck portion that wraps around and contacts a portion of a subject's neck;
a first port in fluid communication with the chamber;
a fluid delivery system in fluid communication with the first port and adapted to deliver a first gas to the chamber as the subject naturally respires;
a sensor in fluid communication with the chamber and adapted to monitor carbon dioxide in a second gas exhaled from the subject as the subject naturally respires;
a securing element joined with the body, the securing element including an elongate portion that wraps at least partially around a subject's neck to secure the body to the neck.

18. The tracheotomy apparatus of claim 17 wherein the sensor is coupled to an alarm adapted to activate when carbon dioxide monitored by the sensor falls below a pre-selected level.

19. The tracheotomy apparatus of claim 17 comprising a pressure sensor in fluid communication with the chamber.

20. The tracheotomy apparatus of claim 17 wherein the pressure sensor is coupled to an alarm adapted to activate when pressure of the second gas falls below a pre-selected level.
